(19) United States
(12) Patent Application Publication
(10) Pub. No.: US 2007/0124596 A1
(43) Pub. Date: May 31, 2007

(54) INTEGRATED GAS SUPPLY SYSTEM AND COMPUTER NETWORK FOR ENHANCED USER SERVICE

(76) Inventors: Henri Chevrel, Dallas, TX (US); Vinod Raghavan, Dallas, TX (US); Kevin McKean, Houston, TX (US); Anthony Hudson, Murphy, TX (US)

Correspondence Address: AIR LIQUIDE, 2700 POST OAK BOULEVARD, SUITE 1800, HOUSTON, TX, 77056, US

(21) Appl. No.: 11/622,372

(22) Filed: Jan. 11, 2007

Related U.S. Application Data
(62) Division of application No. 10/303,630, filed on Nov. 25, 2002.
(60) Provisional application No. 60/346,356, filed on Jan. 7, 2002.

(51) Int. Cl. H04L 9/00

(52) U.S. Cl. 713/182

(57) ABSTRACT

The present invention generally describes a system and process for the integration of a gas supply system and a computer network.

### CROSS REFERENCE TO RELATED APPLICATION

This application is a divisional of application Ser. No. 10/303,630, filed on Nov. 25, 2002.

### BACKGROUND

1. Field of the Invention

The present invention relates generally to methods and systems for the integration of a gas supply system and a computer network.

2. Description of the Background

As used herein, the term “HTML” means and refers to hypertext markup language. As used herein, the term “JSP” means and refers to a Java Script Page. Many of the illustrations and embodiments hereinafter described will be examples of JSP pages prompting a user for data or supplying information.

The Internet has revolutionized the modern world, connecting millions of minds over a largely unrestricted border. In general, the Internet allows communication between people from one computer to another. These connected computers have allowed almost immediate access to information and communications around the world through an assemblage of networks, nodes, portals, and/or the like. The Internet is most commonly accessed through an Internet Service Provider (ISP). ISPs provide varying levels of service and/or connection, including ISDN, DSL, T4, dial-up, and the like.

Many companies, government bodies, and/or organizations have made use of the Internet to enhance accessibility of information. Many of these entities have found that the increased levels of accessibility have increased customer satisfaction, efficiency of operations, and the like.

### SUMMARY

The present invention provides for an integration of systems to facilitate access and update for both internal employees and external customers. The present invention was designed to provide users greater access, control, and/or adaptability over gas supplies, customer orders, safety information, and related facets. Embodiments of the present invention allow access to a variety of parameters related to a gas supply source systems through one primary portal. In various embodiments, users of the present invention are allowed pre-defined access that is at least partially dependent upon a level of access granted to the user. More specifically, embodiments of the present invention allow different access and functioning for each particular user. Other embodiments of the present invention have security features to provide control over access and provide alerts for system conditions.

In use, various embodiments of the present invention are designed to accommodate a heterogeneous mix of users both internal and external through pre-existing groups and individual profiles, with supervisory control over access and features; organization and/or presentation of present marketing, best practices, quality and safety information tied through a single interface; organization and/or presentation of reports, manuals, and other documents made available without specific internal system connectivity initiated by the user; capability to view and/or update data; organization, presentation and communication of a wide alerts from source systems and/or related systems as desired, including selectivity in transmission of alert to a desired user and/or a desired user profile; information sharing; an enhanced path of communication, such as through contact lists, emergency numbers, phonebooks and the like; auto-paging and messaging capabilities; access through a single logon screen; trending and graphical information on any of the system sources and the like; ability for data entered to function on at least a batch, semi-real time and real time processing; organization and presentation of information to standardize communications, both internal and external; and the like.

The present invention will provide user service enhancement, including both internal user, external user, and/or customer. A system of the present invention will enable an organization to become “e” enabled, enabled through electronic commerce and information source. In an embodiment, the system will provide an organization's internal users, customers and suppliers with tools and collaborative processes for conducting business over the Internet. Embodiments of the present invention are specifically designed to support world-wide operations with flexibility and adaptability to support new systems and processes as they are brought online.

Embodiments of the present invention are designed to allow for and provide for process enhancement. Embodiments of the present invention will provide enhancement to customer service; accommodate a heterogeneous mix of users both internal and external through pre-existing groups and individual profiles with supervisory control of access and features; provide a way to organize and present marketing, best practice, quality and safety information from across the corporation tied in through a single interface; provide sets of relevant reports, manuals, and other documents made available without specific internal system connectivity initiated by the user; allow for capability to view and/or update related data from more that one source system; provide for a simple way for Alerts to be broadcast from major system sources such as organization financials, invoice and billing; establish a collaborative mechanism through information interchange via chat, e-mail connectivity, and messaging to enhance both the internal and external user's Portal experience; allow a quick and efficient way to communicate through contact lists and emergency numbers with auto-paging and messaging capabilities; establish a single logon, where feasible, to the organization information which may include data from laboratory management and data, quality management, customer service management, quality management, safety management, environmental management, and the like over a series of source databases; trending and historical information taken from corporate data sources and graphically displayed; entering data into the portal that updates source systems in batch, near-real and real time, and/or the like.

A portal that can serve as a model for use throughout an organization, including internationally linking through standardized protocols to local source systems

Embodiments of the present invention will provide cost reductions. Such decrease in costs may be attributable to lower information system training costs; increase operating efficiencies (internal & external customers); and/or, increase in employee productivityThese and other objects, features, and advantages of the present invention will become apparent from the drawings, the descriptions given herein, and the appended claims.

### BRIEF DESCRIPTION OF THE DRAWINGS

FIG. 1 is an illustration of an embodiment of the present invention.

FIG. 2 is an illustration of a login screen for various embodiments of the present invention.

FIG. 3 is an illustration of an embodiment system of the present invention.

FIG. 4a is an illustration of an embodiment of a computer hooked to an embodiment of a system of the present invention.

FIG. 4b is an illustration of an embodiment of a terminal hooked to an embodiment of a system of the present invention.

While the present invention will be described in connection with presently preferred embodiments, it will be understood that it is not intended to limit the invention to those embodiments. On the contrary, it is intended to cover all alternatives, modifications, and equivalents included within the spirit of the invention.

### DETAILED DESCRIPTION

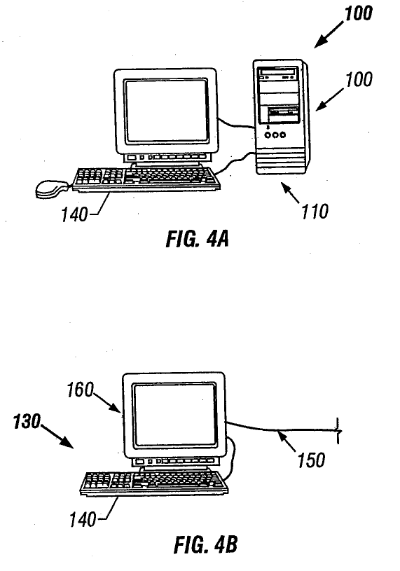

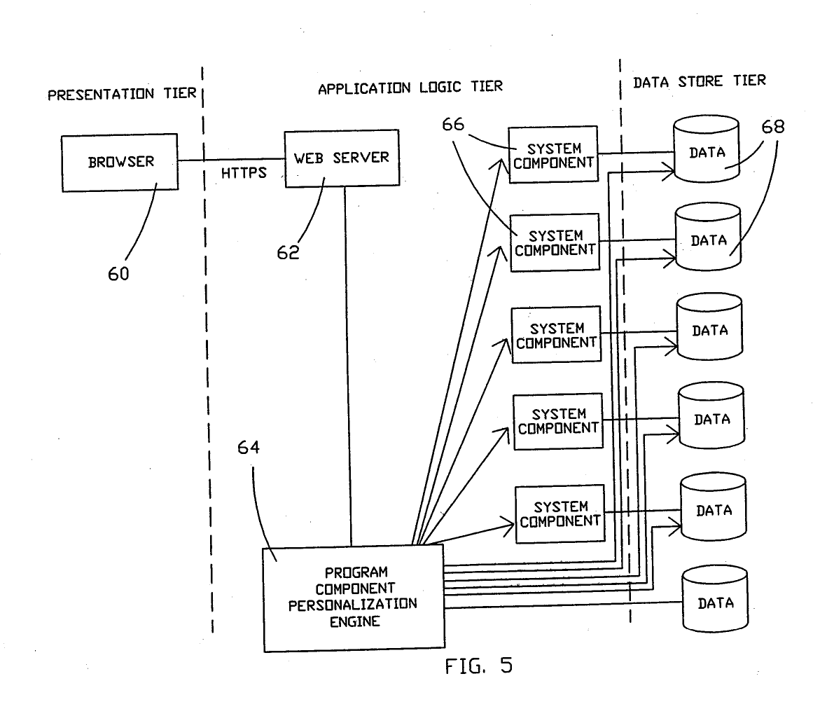

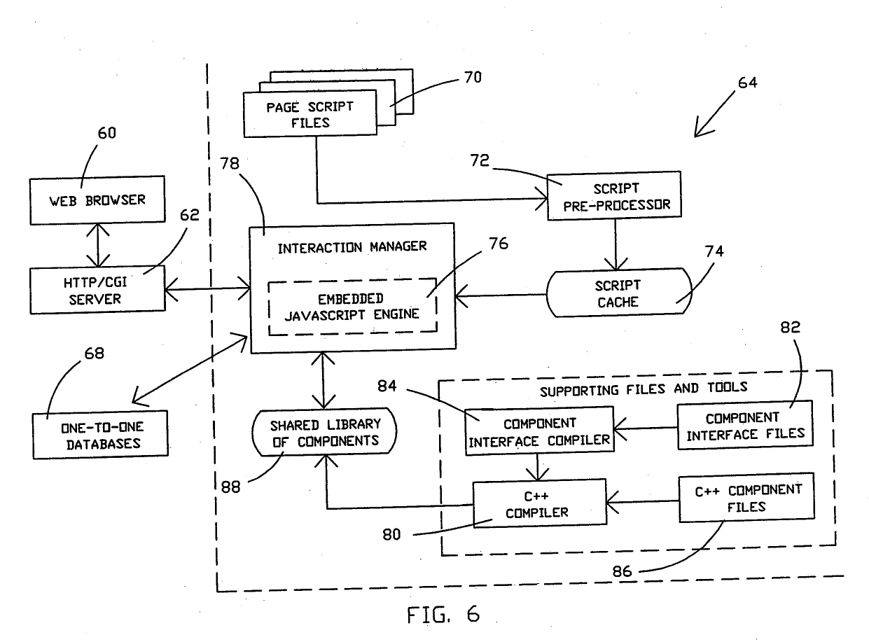

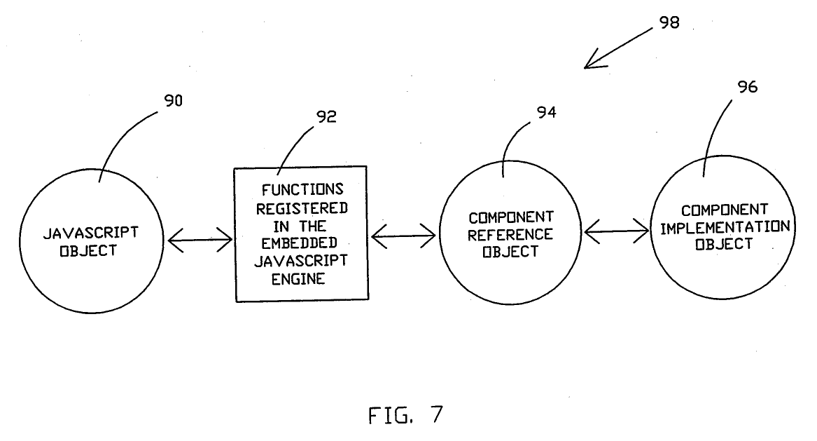

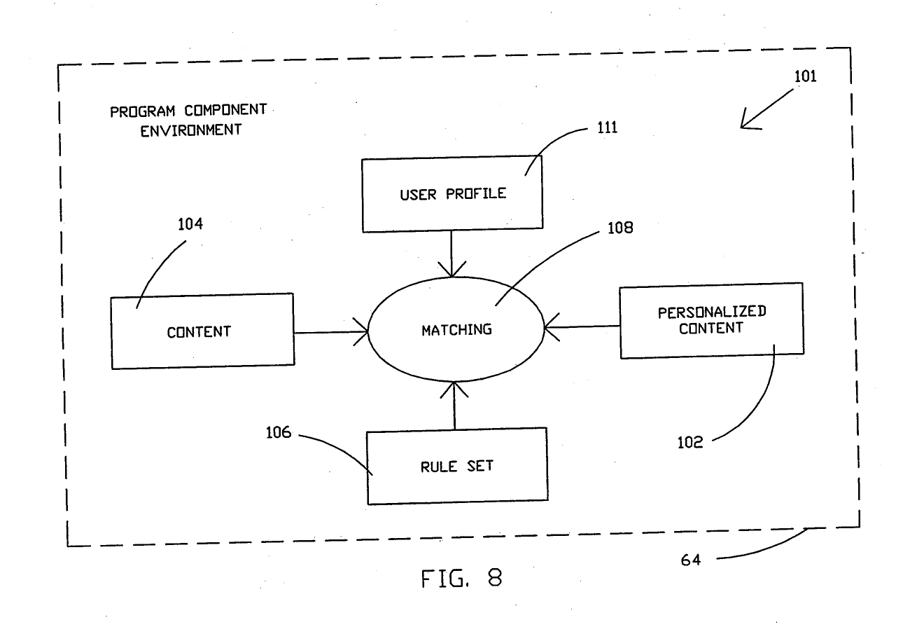

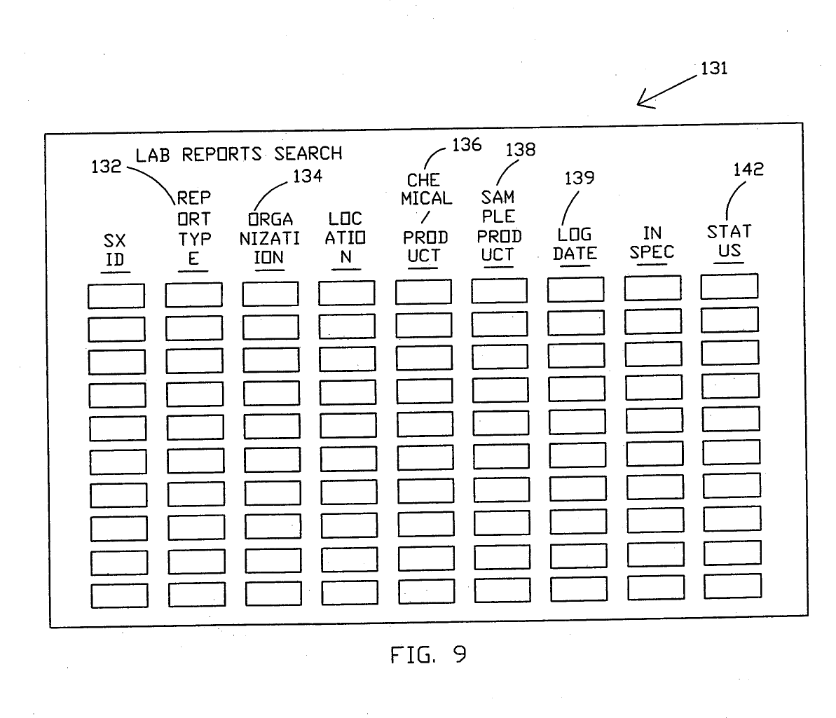

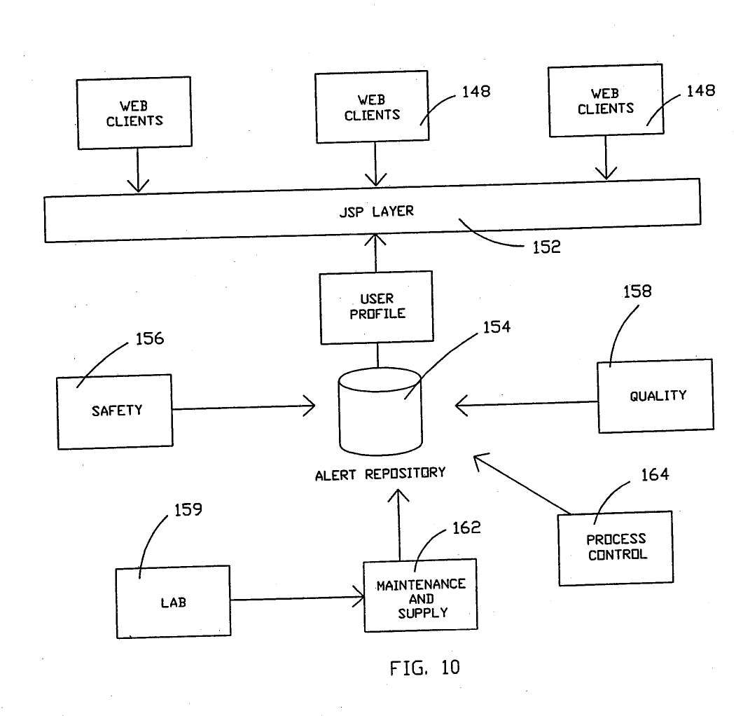

Generally, embodiments of the present invention allow access of a gas supply system to a variety of users in a variety of manners. In an embodiment, access of the gas supply system is allowed through a computer. Referring to FIG. 4b, computer 100 may be any computer capable of processing data, such as from a database 110, as well as data input for comparison, such as from a keyboard 140. However, other data storage devices and methods will be readily apparent to those of ordinary skill in the art.

As those skilled in the computer arts will recognize, computer 100 may range in size and complexity from a mainframe computer such as an INTERNATIONAL BUSINESS MACHINES 3090 series to a personal computer such as those utilizing a microprocessor such as an 80×86 or PENTIUM processor manufactured by INTEL CORP. Memory device 120 is accessible to computer 100 through any means such as those apparent to those skilled in the computer arts such as a local hard magnetic medium drive, CDROM, DVDROM, magento-optical devices, and the like. In an alternative embodiment, memory device 120 may be a separate data storage device operatively in communications with computer 100 such as by LAN, or a read-only electronic memory device such ROM. Other embodiments may utilize a terminal 130.

Referring to FIG. 4b, terminal 130 may be collocated with computer 10 which has database (not shown) and which does the comparison, or, as in a preferred mode, is operatively connected to computer 100 through data communications network 150. In the preferred embodiment, input terminal 140 and output terminal 160 may be a single terminal 20 such as a personal computer. Additionally, terminal 130 may be a device capable with interactive interfacing capabilities such as WEBTV marketed by SONY CORP or any other device capable of interactive interface with computer 10. Further, input terminal 140 may be a batch input device such as, by way of example and not limitation, a card reader, a CDROM reader, an optical recognition device, a magnetic media device such as diskette or tape, or any combination thereof.

Output terminal 160 may be an interactive visual device such as a video terminal, computer terminal, or personal computer; a hard copy output device such as a printer or a facsimile; a memory device such as a CDROM or DVDROM; an electronic device such as a file resident in a memory device such as a file on magnetic or optical media; or any combination thereof.

Data communications network 150 may include terminal multiplexers, local area networks, wide area networks, dial-up bulletin boards, packet switched networks, private networks, public networks, cellular packet data networks, or any combination thereof. In the preferred embodiment, data communications network 150 is the Internet with clients and agents accessing computer 100 through any Internet accessing means, including by way of example and not limitation dial-up, DSL, ISDN, T-1, T-3, satellite, and cable.

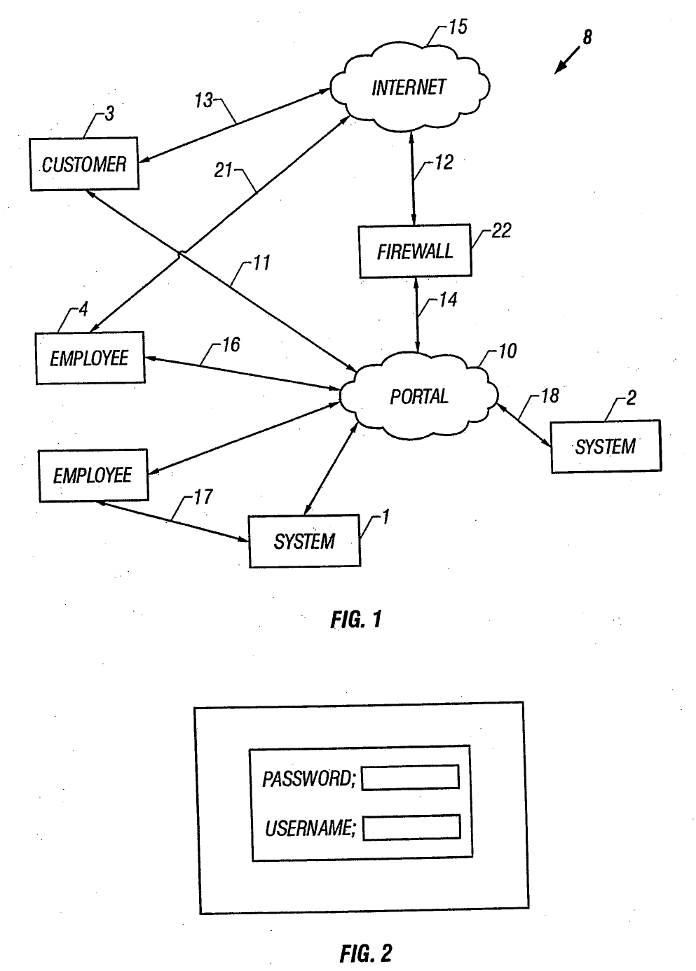

Referring now to the figures, and more particularly to FIG. 1a, there is shown a system 8, an embodiment of the present invention. Embodiments of the present invention allow for the integration and/or connection of a plurality of systems, as described above in an embodiment, comprising independent and dependant systems, as will be discussed more fully below. In an embodiment, access to the plurality of systems 1,2 is provided and/or allowed across a portal 10. Portal 10 is illustrative of a centralized location and/or connection, such as a network, for a focusing of connections to both existing and later created source system(s) 1,2.

In a general embodiment, as shown in FIG. 1, access to systems 1,2 by a user(s) 3,4 is provided either across a portal 10 or directly. Users are divided into at least two groups, internal and external users. Internal user(s) may comprise employees 4, contractors, and/or the like. External user(s) may comprise customer(s) 3, outside sales, and/or the like. For an external user, such as customer 3, access to portal 10 is provided across Internet 15. In an embodiment, customer 3 establishes a connection/interface to the Internet 15, as is common in the art, such as through ISP 13. Customer 3 then enters a web address, such as an http address, corresponding to the address of portal 10 to navigate to the web, as is common in the art. Web addresses may be entered by any method common in the art, such as keystrokes, mouse-clicking a button, and the like.

In an embodiment, access through portal 10 is controlled by a firewall 22. Any firewall common in the art is suitable for embodiments of the present invention. Embodiments of a firewall suitable for the present invention would control access by querying a user attempting to gain access for at least one password. Other embodiments may simply require the entry of a password without specifically querying for the password, as is common in the art. Various embodiments further query for and/or require a user group name and/or group password. In an embodiment, as shown in FIG. 2, query is made for a password and a user name. However, the use of passwords and such is well known in the art and any system is sufficient for various embodiments of the present invention.

Further methods of access for external users comprise direct access and limited direct access across connection 11. Connection 11 may be any connection common in the art, such as dial up, landline, radio, and the like. In various embodiments, an external user can establish a connection directly to portal 10. In various embodiments, connection 11 is through firewall 22. In other embodiments, an external user can connect through an internal user. In other embodiments, an external user connects to an internal user.

Internal users, or users that are connected to an internal organization system and/or network, are connected across connection(s) 16 to portal 10. Other embodiments connect directly to system 1, such as through a connection 17. Access across portal 10 and/or system 1 should be controlled by a password as for external users. However, in most embodiments, an internal user will already be connected across firewall 22.

Upon entering and acceptance of a password, various embodiments display a screen that can be personalized as per the desires and/or responsibilities of the user, often referred to as a homepage. Homepages may be custom tailored for each individual user. Various embodiments allow a user to include additional information from outside an organization's source system and/or website. In various embodiments, a standardized screen is displayed with various menu choices that can be dependent upon the username/password entered by the person or upon the user's directive. It is contemplated that portal 10 allow for a different screens for each user. It is further contemplated that access to source systems can be regulated such that certain users are only allowed access to certain databases and/or certain information within that database.

Source system(s) 1,2 are generally referred to as databases and hold data. In embodiments of the present invention, any of a variety of database(s)/source system(s) can be connected across portal 10, including, but not limited to, nor requiring, laboratory management system, environmental management system, communications, quality incident report(s) and corrective action(s), warehouse management, billing management, order management, maintenance management, alert systems, and/or the like.

In various embodiments, further specificity as to the level of an internal and/or external customer is necessary. In various embodiments, available profiles for internal users include, but are not limited to nor inclusive of, process operators; laboratory staff; warehouse personnel; health/safety and environment; purchasing, sales, and planning; administrative; executive management and/or the like. Profiles established for external users can include, but are not limited to or requiring, suppliers and customers.

Examples of source systems for use in varying embodiments of the present invention comprise laboratory management, safety, environmental management, communications, quality management, quality incident reports, alerts, tracking, shipping, best practices, billing, ordering, maintenance management, warehouse management, and/or the like. Further embodiments may include source systems only accessible by internal users, such as contact lists and the like.

External user, such as customer 3, will be able to perform numerous functions through a system of the present invention related to the integration of a gas supply system and a computer network.

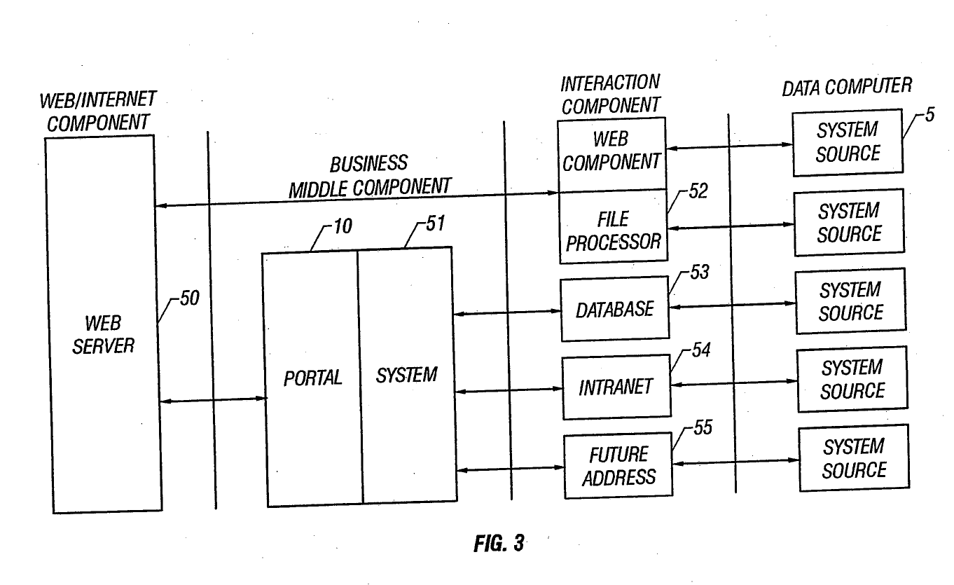

Another illustration of a system of the present invention is depicted in FIG. 3. FIG. 3 illustrates general components of an embodiment of the present invention. The embodiment of FIG. 3 is divided into four sections; web component, business component, interaction component, and source data component. Access to various embodiments of the gas supply system of the present invention is gained from the World Wide Web, such as through a web server 50. Web server 50 will have at least one individual and particular address or location. To gain access to the system of the present invention, a user or users will enter the address in a web browser, such as Netscape or Internet Explorer.

Access to the system of the present invention will begin with access to portal 10, as heretofore described. At portal 10, several access options will be available. In one embodiment, a user will enter a password, logon name, and/or the like to gain access to system 51. In another embodiment, a non-user will be able to access various parts of the system 51 t are particularly suited for safety and of benefit to the general public.

Generally, embodiments of the present invention are designed to provide access and connectivity to a plurality of systems 5. Each system 5 may be a like system or a different system. In particular, embodiments of the present invention are designed to allow access to pre-existing systems across a system of the present invention, thereby allowing a user with multiple programs of varying age to connect at least a portion of the programs and/or databases without requiring updates to every system component. It is specifically appreciated that time and money will be saved from the integration of the various systems rather than the wholesale replacement of every system. The time and money saved will cover at least the expense of replacing the system and the expense of retraining required for a new system. Embodiments of the present invention allow users to continue use of a familiar system while allowing that system to be interconnected and/or integrated with other systems.

Embodiments of the present invention utilize and interaction component to monitor, control, allow, and/or manage a users access to data in the various system sources 5. Various interaction components of the present invention include further web components and file processors 52, databases 53, intranet 54, future addresses/systems (addons) 55, and/or the like.

In an embodiment, the Presentation Tier, Application Logic Tier, and the Data Store Tier are described in the following illustration: 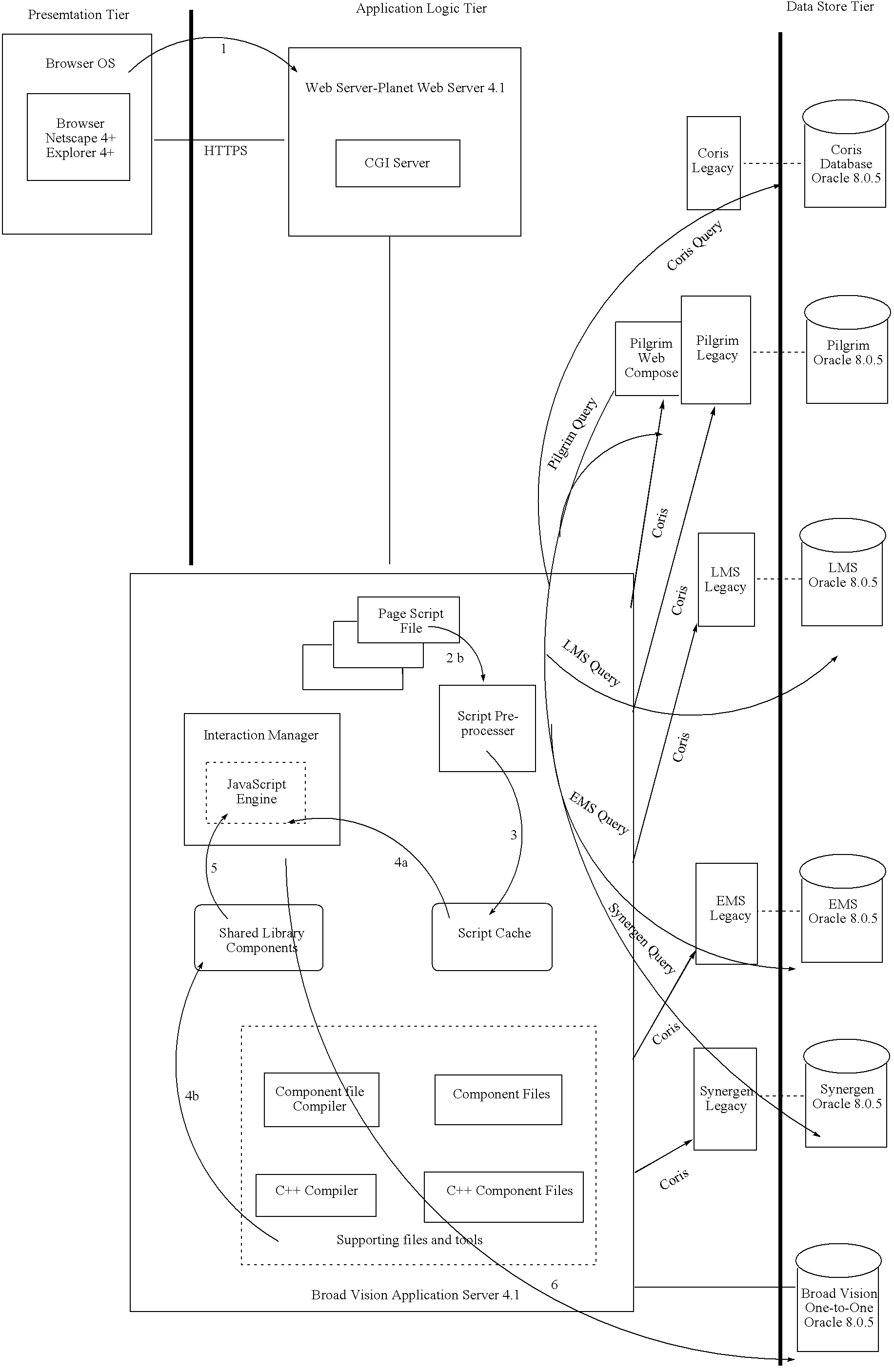
Presentation Tier

The Web tier interacts with the system portal client browsers, via the chosen web server, such as Netscape Server or Internet Explorer Sever. The technology used to accomplish this is the Java Script Pages inside of Program component, a computer program. A JavaScript Page is a mixture of HTML code and server-side Java Script. The server-side Java Script is used to develop dynamic content. It also accesses a Program component personalization engine. A Design Center inside of the Program component will be used to build functional components and set up personalization through a series of wizards, setup programs. These wizards generate the JavaScript Pages. Developers, programmers of a system of the present invention, will also manually create and edit these Java Script Pages to customize them further. The JavaScript Pages utilize Program components to interact with the organization's gas supply systems at the data level.

Application Logic Tier

The Business/Middle Tier utilizes existing Program component functionality. All business logic is embedded in JavaScript Pages. This allows for access to other databases on the organization gas supply system, such as laboratory management, safety, environmental management, communications, quality management, quality incident reports, alerts, tracking, shipping, best practices, billing, ordering, maintenance management, warehouse management, and/or the like. Further embodiments may provide access through the application tier to other source systems, by qualified individuals, such as source systems only accessible by internal users, like contact lists and the like.

Data Store Tier

Data from the organization's gas supply system, such as laboratory management, safety, environmental management, communications, quality management, quality incident reports, alerts, tracking, shipping, best practices, billing, ordering, maintenance management, warehouse management, and/or the like, will be accessed at the data level to provide necessary functionality. The data store tier is particularly designed to provide functionality to stored data, including query functions and viewing functions.

A general flow of work in an embodiment is as depicted in the diagram
The browser makes a request from the web server.
Page script files, JSP pages, request some type of transaction from a server running Program component. The UI layer is represented by the JSP pages. All business logic will be delegated to corresponding Business Objects within the Program component object component layer.
For direct access to systems such as laboratory management, safety, environmental management, communications, quality management, quality incident reports, alerts, tracking, shipping, best practices, billing, ordering, maintenance management, warehouse management, and/or the like, the integrated gas supply system will establish a connection to underlining system architecture. This will only be available to users within the organization's firewall.
For query functionality to systems, such as laboratory management, safety, environmental management, communications, quality management, quality incident reports, alerts, tracking, shipping, best practices, billing, ordering, maintenance management, warehouse management, and/or the like, the organization's system, in an embodiment, will use a JSP Component Layer and access those databases at the data level through dedicated server systems or portions of systems corresponding to each application.
User profile information will be store on a database

In an embodiment, a website of the present invention may have architectural blocks as hereinafter shown in the following illustration:

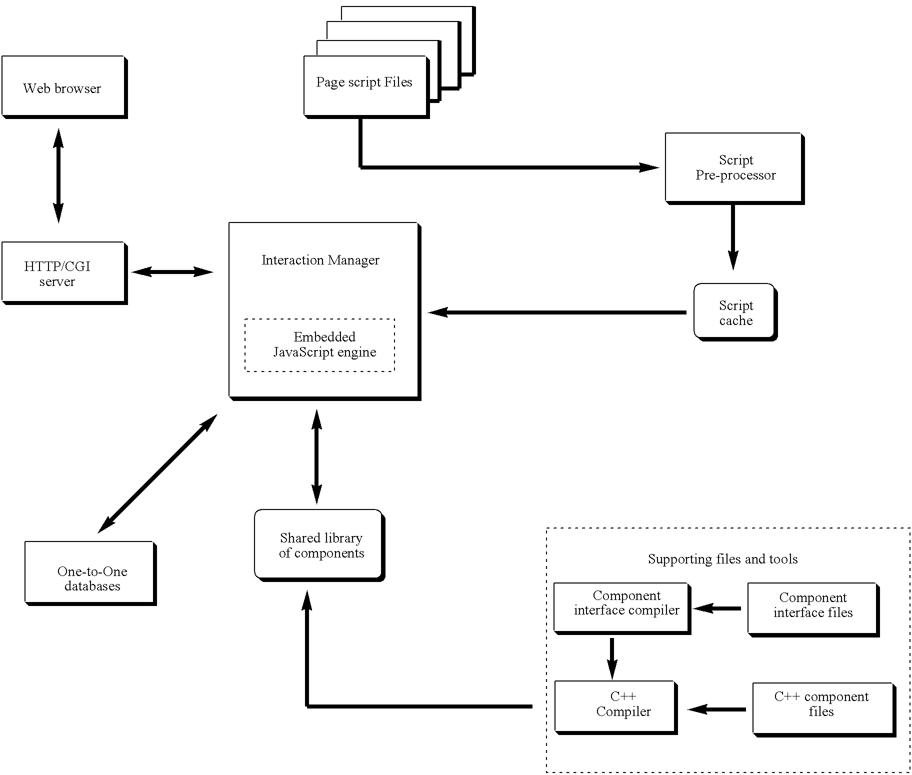

The architectural blocks illustrated above may be described as follows:

A web browser is a visitor's point of contact with the site's HTTP server. The HTTP server is a web site's connection to the World Wide Web. In various embodiments, the various methods of the present invention add a particular identifier to servers to facilitate transfer of data across the gas supply system. Page scripts and/or page script files are text files with a .jsp extension. In various embodiments, page scripts can contain server-side JavaScript, HTML tags, text, and references to Program components, such as C++ or other. The files can also contain Java object references or other text that is understood by an HTML browser. Typically, HTML tags specify that part of the information to be sent to the browser that never changes. Server-side JavaScript and Program components specify that portion of the information, which is dynamically generated. The script preprocessor converts everything in the page script into pure server-side JavaScript. After the script pre-processor converts the page, the page is held in the script cache and then run by the embedded JavaScript engine. Note that page scripts are not the same as Web pages. More than one page script can be used to build a single Web page.

The interaction manager is the system's primary communication and process control for handling interactions with the HTTP server. The Interaction Manager receives data from the HTTP server and returns data to it, and controls the processing of page scripts and most interactions with the underlying One-To-One servers. The Interaction Manager contains an embedded JavaScript engine. When the HTTP server requests a page script, the Interaction Manager does the following:
1. Gets the appropriate path (address) to an appropriate environment
2. Validates the path (a path is the address or location for the data).
3. Checks the script cache for a compiled script.
4. If there is no compiled script, it runs the script preprocessor and stores the compiled script in the cache.
5. Runs the script in the embedded JavaScript engine.

The embedded JavaScript engine runs the server-side JavaScript. Embodiments of the system may be embedded in the browsers JavaScript engine directly into the Interaction Manager without any changes to the browser. Embodiments of this type may run industry standard JavaScript. This enables embodiments of the present invention to use standard JavaScript or like program on the server side of the Web connection in combination with system components to produce dynamic Web pages and Web applications. When the JavaScript engine encounters a reference to a system component, it makes calls into the appropriate compiled code, such as C++ code and the like, that constitutes the referenced system component.

The script preprocessor converts a page script into pure server-side JavaScript. The script preprocessor accomplishes this by identifying all JavaScript that is to be run on the server-side. It then encapsulates all remaining text, including HTML tags, browser-side JavaScript, or plain text, within Response.write constructs.

A script cache is a cache of compiled page scripts. An Interaction Manager application calls the script a preprocessor on a given page script only once, no matter how many different sessions in that Interaction Manager refer to that page script. When the cache is flushed, the Interaction Manager again calls the script preprocessor on each page script as it is needed. The script cache contains a compiled version of the script page that is produced by the JavaScript engine embedded in the Interaction Manager.

Component interface files define the interface between JavaScript and design components. These files specify the methods, attributes, and object creation operations that you can call in page scripts to access the functionality of the design components.

The Component Interface Compiler generates C++ source code, which provides callback functions that are registered with the embedded JavaScript engine. These callback functions provide the connection between JavaScript and the design objects. The Component Interface Compiler compiles the component interface files into C++ source files, which are then compiled by the C++ compiler.

Component definitions are written in C++, or other like language. These JavaScript-visible components are C++ objects which contain code to do particular tasks related to providing the information sent to the visitor's browser or processing the data received from the browser. The C++ components are compiled into one or more shared object libraries, which are loaded by the Interaction Manager when it begins running.

A shared library of components is a set of shared object libraries, which are loaded by the Interaction Manager when it begins executing.

Operation:

An example of the operation of an embodiment of the present invention is as follows:

In an embodiment, the system program components of the present invention are C++ objects that are visible to JavaScript, that is, they can be called directly from server-side JavaScript scripts. These components are composed of three layers as described in the following table. Each of these application components are used in the overall development of the system Portal, in various embodiments of the preset invention:

| Layer | Purpose |
|---|---|
| JavaScript Interface | Allows BroadVision components to be used in |
| | JavaScript scripts. |
| | Specifies the methods and attributes that can |
| | be called on a component in a JavaScript script. |
| Component | Passes information between the JavaScript layer and |
| reference | the component Implementation. Also provides the |
| | memory management semantics. |
| Component | Does most of the actual work. C++ classes in |
| implementation | this layer make calls into the BroadVision C++ |
| | client-side toolkit or directly into the |
| | back-end servers via IDL interfaces. |

When a system program component is used in a script of the present invention, there is an object for each of the three layers. The JavaScript layer includes a set of functions for each Program component that are registered with the Netscape JavaScript engine embedded in the Interaction Manager. When the embedded JavaScript engine encounters a reference to a Program component it runs these registered functions. These functions, in turn, make calls into the component reference layer that communicates with component implementation classes. This series of calls looks like this:

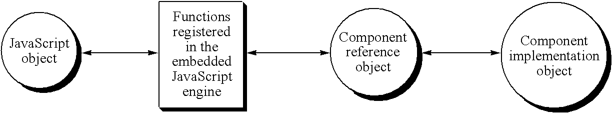

For each type of Program component, there are a set of registered functions that provide calls into the component reference layer object for a particular instance of that component type. Program components are useful within server-side JavaScript scripts that can run in the embedded JavaScript engine. Various embodiments of such scripts have the following characteristics:
Uses syntax similar to Microsoft active server pages.
Support JavaScript-visible component objects that conform to the Program component technology.
Uses industry standard JavaScript.
   JavaScript is an interpreted language that is loosely typed and has built-in automatic memory management. C++ is a compiled language that is very strongly typed and requires adherence to specific memory management semantics.

Presentation of the system portal of the present invention can be of any common browser, such as Netscape or Internet Explorer Browser with a script engine for processing the Javascript. Presentation of the system portal will be alike for every user. However, features are built into embodiments of the invention to allow a user to personalize the system portal. The scripts, both the client side script and server side script, make the presentation layer dynamic and support the complete separation of application logic from presentation logic. The client side script, interpreted by the web browser, handles the simple, independent logic such as syntactic validation. The server side scripts, which are interpreted by the script engine within the interaction manager, determine the action once a new request is received. The server side script executes the application objects (Business Objects) hosted in the processing layer.

Various embodiments of a system program and/or system portal of the present invention provide components for high speed caching, session management, and security management such as SSL. Various bit sized encryption may be used with embodiments of the present invention.

The operation/processing layer of the system program of the present invention consists of at least 2 components; the business operation component and the vertical functional component. Each component processes a different system function. A business operation package will handle the personalization, content management, and the matching rules. A vertical functional component will handle the interfacing with the backend interaction as well as the necessary logic processing, such as business logic and interfacing the existing organization systems.

A business operation component, embodiments of which include the Content Management, Matching rules, and Personalization, determines the system program behavior according to the rules specified from command center. The system program of the present invention is preferably based upon client-server existing architecture. This feature allows full control of the business behavior in each existing system in real time to perform tasks like adding new rules for incentives, advertisements, observation, defining alerts on certain conditions, and generating targeted email to reach a targeted audience.

The Visitor Interaction component is particularly designed to enhance user interactivity with systems of the system program of the present invention. The visitor interaction component is designed to allow limited access to users without requiring formal logging on or entry into the system. Such functionality allowed without logging on includes navigation through the pages, utilization of certain tools, access to safety pages, quality pages, organization information, help pages, articles, information about products, and/or the like.

Embodiments of the present invention utilize output content that is selectively personalized. In general, an output screen of the present invention will contain at least one menu item with at least one icon or selectable zone for entry into at least one of a variety of systems within the system portal. Preferred embodiments have a plurality of menu items. The output is the personalized content. Each user will be granted access to menu items that are within the users granted level of security access. The following illustration details an embodiment of the present invention's interaction with personalization of content.

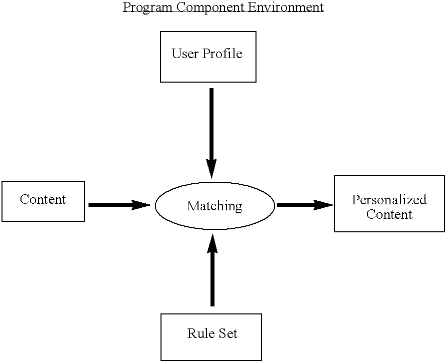

Various embodiments of the present invention system program will present screens to a user, such as the following:

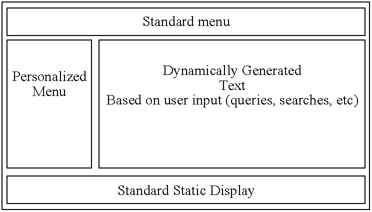

Access to and operation of embodiments of the gas supply system of the present invention is achieved when the user, whether external or internal, clicks a link or button (on the menu or on at least one of the menus) on the system portal, a generated page is sent back to the browser. In an embodiment, the following steps are performed: 1) User enters their username and password and clicks Login.and/or Logon; 2) The click action sends the control back to the same page; 3) Create a username method; 4) Validation of the user's password; If the usemame and/or password is not valid, the login page is redisplayed with an error message. Otherwise proceed; 5) Check to see if the user is logging in for the first time. If the user is logging on for the first time then they are directed to the change password JSP page, otherwise the user is directed to the home page. 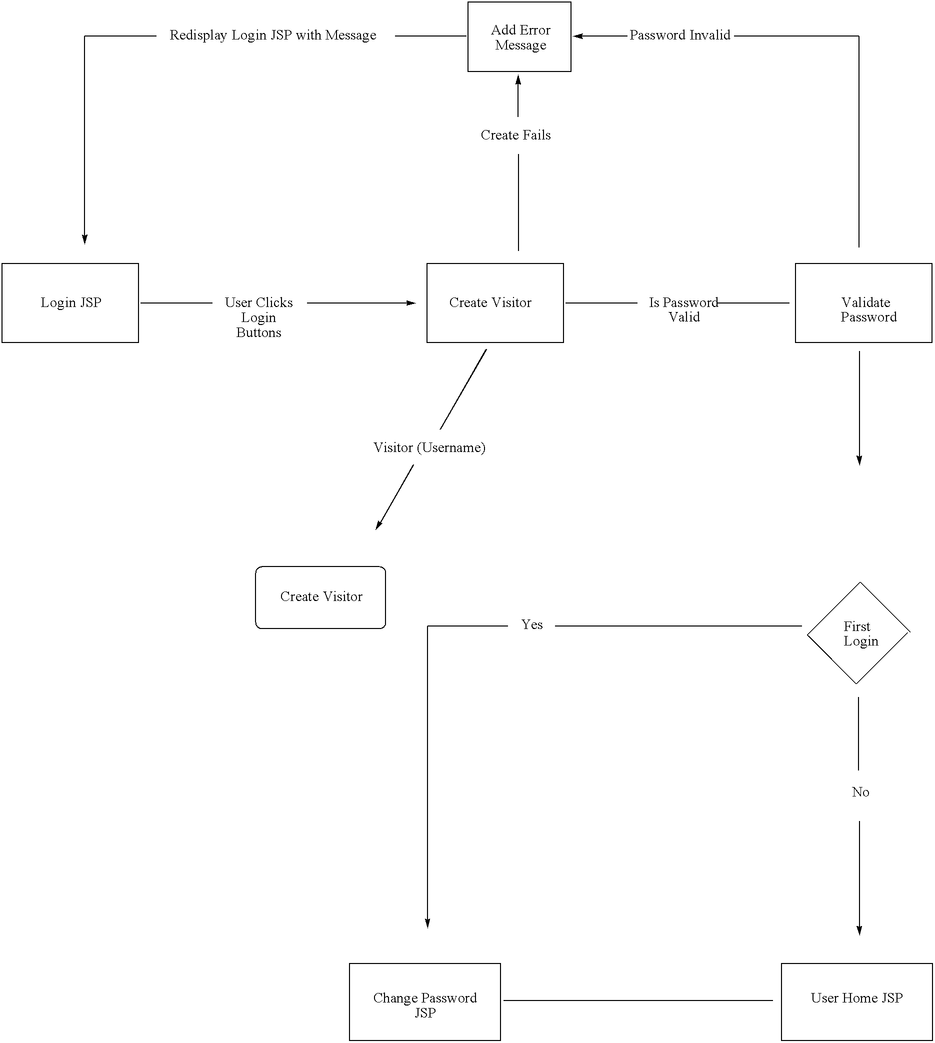
For establishing a new account, in various embodiments of the present invention, the system queries the new user for information to establish a new account. In one embodiment, 1)

User clicks on “New Account Request” from the menu; 2) User fills out the required fields and clicks “submit;” 3) The information is collected and formatted; 4) An email is generated and sent to the administrator; and, 5) The Administrator is responsible for approving and adding the user.

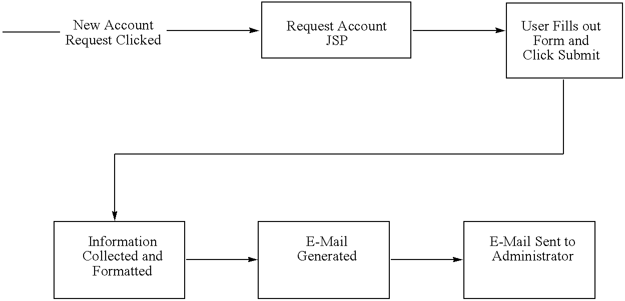

In an embodiment, account information collected may is stored in a data matrix or database, such as:

| | Tester 1 |
|---|---|
| First Name | John |
| Last Name | Doe |
| e-mail | John.Doe@Organization.com |
| Phone # | (###) ###-#### |
| Organization | Division I |
| Location | City |
| User Group | Process Control |
| Account Access | |
| Info. | |
| User Name | John Doe |
| Password | ******* |
| Department | Process |
| Organization | US-Organization |
| Access Allowed | |
| Customer # 1 | ######### |
| Sub # 1 | 01 |
| Customer # 2 | ######### |
| Sub # 2 | 02 |
| Customer # 3 | ######### |
| Sub # 3 | 03 |
| Customer # 4 | ######### |
| Sub # 4 | 04 |
| Customer # 5 | ######### |
| Sub # 5 | 05 |

The above illustration only represents one of many possible data entry/user account screens possible. In this embodiment, three data groups are collected. One, personal information on the user, such as name and the like. Two, account access information, such as password and username. Three, account access allowed, such as which customer's information can be accessed by the user and/or what information can be accessed.

This information can provide basic information for embodiments of the invention as needed. In an embodiment, this information is maintained within the organization's internal directory and may only be modified from a user within the firewall of the system, to protect system integrity. In other embodiments, access and modification is allowed to select users.

Other embodiments incorporate like procedures for a variety of functionality, including, but not limited to, security updates, password changes (manual or automatic), new user forms, and the like.

In an embodiment, a gas supply system of the present invention is provided with a feedback section. The feedback section allows internal users, external customers and the like to make comments about the system to a system manager or the like. In an embodiment, comments are classified in different categories, thereby allowing a manager of the particular category to respond to and/or accept the comment. Further embodiments may incorporate response groups or problem solving groups to address each comment and/or a comment that is determined credible. In an embodiment, the feedback function enables an internal user or customer to view, complete, and email a system feedback form to a system manager. The feedback form is used to gather comments, suggestions, evaluations, and other concerns that users may have pertaining to the system portal. In an embodiment, the feedback form consists of a single, online request form residing on the system Portal. The form is accessible by selecting the “Feedback” link located under the “Support” menu on an embodiment of the system navigation bar. Various embodiments further incorporate the use of verification pages and/or replies that are automatically sent to the user making the comment when the manager views the comment.

In an embodiment, the Feedback Form simply consists of HTML and JavaScript, both of which are encapsulated into a single JavaScript Page (JSP). The HTML contains a form that collects the information fields entered by the user. The JavaScript ensures that all the fields are filled out and formatted correctly when the user presses the “Submit” button. Once the information fields are verified, they are passed to the Feedback Result JSP. The Feedback Result JSP also contains a combination of HTML and JavaScript. First, the information fields are formatted into a single text message, which is later inserted into the body of an email message. Various embodiments of the present invention are particularly adapted

Other embodiments further incorporate functions to allow a user, both internal and external, to order and/or view a Service Request form, complete it, and email it to the appropriate organization representative and/or print it. The Service Request consists of a single, online request form residing on the system portal. In an embodiment, access to this form is controlled by the system, such that only certain users can gain access. Access, in an embodiment, may be gained through a link located under a menu bar. Links, as used herein, refer to information locations within a system of the present invention and can provide automatic connection.

In an embodiment for requesting service from a department, such as from a laboratory, quality assurance center, environmental protection center, production facility, and/or the like, a user would follow a procedure as such: 1) User selects the “Labpack Service” link from the menu; 2) User fills out the required fields and clicks “submit;” 3) The information is collected and formatted; 4) An email is generated to the department manager; 5) The email is sent to the manager requesting service; and, 6) the system displays a confirmation page to the user to verify that the Service request was made.

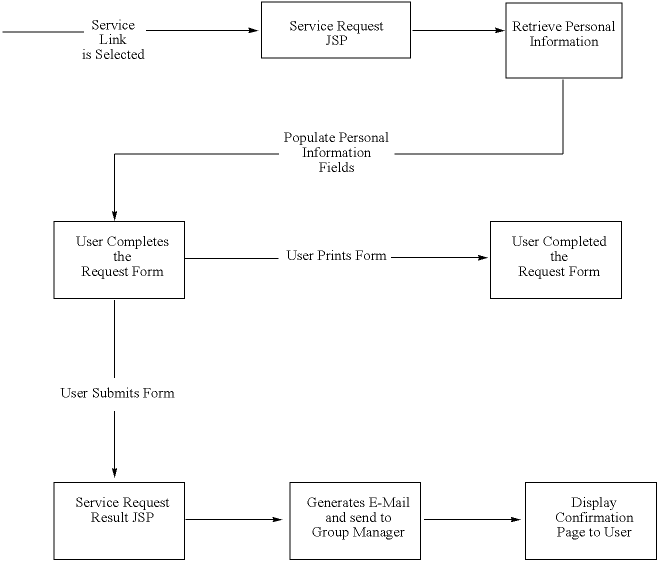

As with all of the functions of the system, much of the required information will automatically be loaded from the user's personal information into fields of the function.

The service request form simply consists of HTML and JavaScript, both of which are encapsulated into a single JavaScript Page (JSP). The HTML contains a form that collects the information fields entered by the user. The JavaScript ensures that all the fields are filled out and formatted correctly prior to allowing the form to be submitted for further processing. The form may automatically be submitted for processing or to submit the form may require action by the user, such as the user pressing a submit button and/or the user controlling a pointing device such as a mouse to select the submit button on a visual display of the system.

Another function provided in embodiments of the present invention is query functionality. Query functionality is a process that enables a user to search requests, orders, and the like. Requests may include the requests mentioned in reference to the service requests above or any comparable request functionality. Orders include, but are not limited to, product orders, supply orders, and the like. Query functionality of the present invention is particularly adapted to accept a wide variety of data for searches, such as 1) Criteria can be partially entered; 2) If date is entered, query function will query data from that date forward; 3) visual and/or audio indicators when no record matches; 4) Query returns a list of identifiers or results based upon the entered data; 5) Data queried may be stored in specific identified sectors to speed computer processing of request, such sectors would allow for updates as necessary to change or modify the data in the sector; 6) results from query can be sent to a printer, screen, electronic mail, another user, 7) and/or the like.

In various embodiments, access time and run time is increased by much of the processing in query functionality occurring on or within the queried function, such that the data processing occurs within components or separate programs that are accessed by a gas supply system of the present invention. In fact, in a preferred embodiment, a gas supply system of the present invention is a manager of a plurality of independent systems, such that the gas supply system only requests data from applications that are run on separate and independent systems. The data queried by the gas supply system can then be loaded through a spreadsheet function and displayed to a user.

In an embodiment, query functionality may be accessed through a web page, such as a search criteria page. The search criteria web page requests information necessary for a query of the proper database. For instance, when querying a customer database, such fields as purchase order number, order date, customer name and/or number may be requested.

Typically, not every field must be filled in prior to submission. In an embodiment, the search criteria page requires one of at least the order number, customer number or name, purchase order number, and order date. Systems of the present invention are particularly configured to accept submitted information, query a database, and return further information. For example, if only a purchase order number is submitted on the search criteria web page and then the form is submitted, a search results page would be displayed listing that purchase order from the database queried. Likewise, if only a customer name was submitted, a search results page would be displayed listing all the orders from that customer in the database queried. Other query options may be made to return various search results pages as is known in the art. However, if no data is found, a return page will be displayed stating that no data was found. An example of a search order follows:

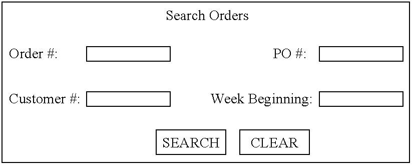

In embodiments with a search results page, the search results page can be configured to provide any information concerning a purchase order, other order, and/or request. In an embodiment, the search results page provides all information about an order, including, but not limited to location where order is being filed, date of order, date order was filled or is expected to be filled, reason for delay (if any), and the like. An example of a search results page follows:

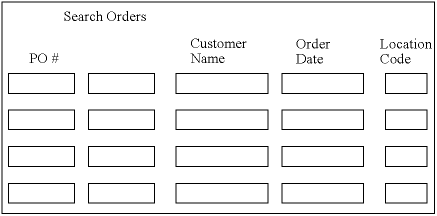

In various embodiments, a more detailed result page may be requested. A more detailed results page may provide additional information, such as originator of order, more thorough breakdown of order, parts of order filled, and the like. An example of a more detailed results page follows:

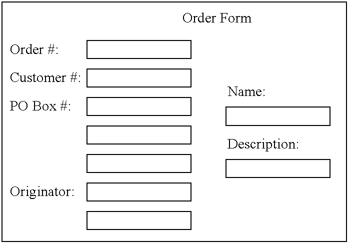

In various embodiments of the present invention, a query function or query type function is provided for forecasts. Included in this forecast query functionality are product demand forecasts, customer specific forecasts, product use forecasts, organization growth forecasts, supply forecasts, facility expansion forecasts, and the like. Other embodiments of the present invention may have a plurality of forecast types, such as product trends, division trends, organization profit trends, raw material trends, price trends, competitor trends, technology trends, electricity usage trends, cost trends, and the like. Forecast querying is accomplished in the same general manner as querying in other areas and may be limited t internal users or users with certain clearance if desired. An embodiment of a process of the present invention for querying uses a process as is generally described following: 1) A User selects the Forecast option; 2) The user fills out the required fields and submits the search, such as by selecting a field with a pointer device and/or manual input of data; 3) The result page is displayed from a query of the database; 4) the user selects a forecast type; and (5) The forecast type is displayed. The forecast may be displayed in the form of a graph, data, and/or the like.

Embodiments of the present invention further have an MSDS query functionality. This function allows users, both internal and external, to search and view MSDS datasheets. MSDS datasheets are Material Safety datasheets. Most every chemical and/or compound handled at an organization will be required to have a current MSDS. These MSDSs provide safety and related information about the chemicals The MSDS query functionality is accessible through inside the firewall and outside the firewall. Various embodiments allow access of the MSDSs to non-users, for example through the logon page of the system. In this manner, the information contained in an MSDS is available to any person, whether a user or not.

In an embodiment, an MSDS query functionality of the present invention is as follows: 1) a user selects MSDS query function, such as through a link on a menu and/or manual entry; 2) the user fills out the required fields and submits the search, such as by selecting and/or clicking a requested field; 3) The Result Set page is displayed; 4) the user selects an MSDS; and, 5) The selected MSDS is displayed. Further embodiments of the query function of the present invention may further incorporate an ability to access multiple MSDSs at one time, search MSDSs by partial entry of chemical or compound, search MSDSs by organization facility (what chemicals are at a specific facility), search MSDSs by safety precautions, and/or the like. In an embodiment a flowchart of an MSDS query is as follows:

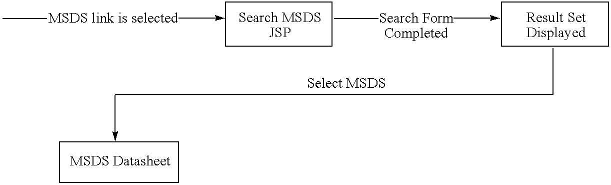

Various embodiments of the system of the present invention that incorporate a MSDS query function make the MSDS query available from every JSP. Other embodiments constantly compare data from the different MSDS sheets and compare data from selected MSDS sheets to other data, such as data from another portion of an order; data from other chemicals kept on a facility, such as a customer facility, to check for any reactions that may occur or toxins that may result from contact of the chemicals or substances. Outside users, such as customers, in some embodiments, will have the ability to load information about their sites and/or complexes, such as potential and/or actual chemicals on site. In this manner, embodiments of the system of the present invention will be able to display warnings and/or JSP pages detailing potential hazards of moving and/or using chemicals on the user's site and/or complex.

Further embodiments of the present invention have lab search query. Lab search results query can be set up to an internal user to search and view lab reports (reports including, but not limited to sample summary reports and certificates of analysis). The search form is accessible through the system to an internal user. The function can be accessible through any number of JSPs. In an embodiment, the lab search query is available from a menu bar on the main page a user encounters after logging on to the system. In other embodiments, external users, such as customers, can gain access to certain features of the lab report ranging from full access to access that is limited to determining whether or not the sample as been run in the laboratory.

To facilitate the entry of lab reports on the system, in various embodiments, members of the lab have access to an internal database that contains the lab reports. In an embodiment, laboratory personnel are granted access to the database only to enter data into the system. In another embodiment, at least one member of the laboratory personnel is granted access sufficient to make changes to entered data. Granting various levels of access to different personnel allows management control over the adjustment of recorded data, thereby enhancing the integrity of the data and providing for quality standards.

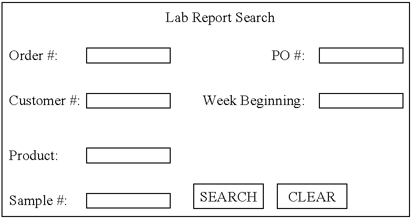

As with other query functions of the present invention, a submitted query will return a results page or a page indicating that no results could be found. An embodiment of a JSP returned is as follows:

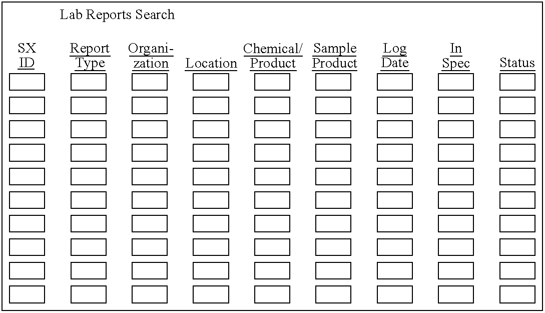

An embodiment of the present invention converts lab results into certificates of analysis.

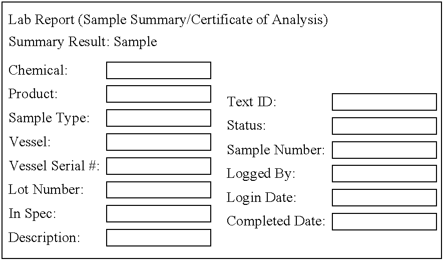

Certificates of analysis (COA) are often created when product is made, usually a batch or certain volume of product. COAs are often required to organize batches or samples of the batches to identify the properties of the product. For example, a tube trailer filled with a nitrogen rich gas would be required to carry a COA stating the purity of the product, other contaminants, and related safety data. Embodiments of the present invention allow for the creation of a COA from any computer with access to the system portal of the present invention. In this manner, rather than requiring an individual from a lab to send a COA from a product, a user can retrieve a COA by running a particular query from the menu item of the gas supply system of the present invention.

Other embodiments can utilize a COA for other accepted purposes. An added benefit of the present invention is the security provided the COAs integrity. Even though multiple users may have access to create a COA, only limited numbers would have access to change a COA. In the event a COA was changed, in certain embodiments, a warning would be issued requiring the destruction of all previous COAs issued on the product. To facilitate such a warning, the production of COAs of the present invention can be coded and controlled, such that the system of the present invention tracks which users requests COAs, keeps copies of the COAs requested, sends notices to other people that a COA has been requested, and/or the like.

Other benefits of embodiments of the present invention include functionality that allows an outside user, a person or entity not related to the system, such as emergency personnel, to be able to quickly access the relevant information about a product. In certain situations, such as a spill or leak, this functionality will greatly enhance safety.

A general procedure a user can utilize in querying the lab search report is as follows: 1) User selects a lab search report link from a menu or other location; 2) the user inputs the required information and submits the query; 3) a result page is displayed with the queried data; 4) the user selects a format for the requested data; and, 5) a report (Sample Summary/Certificate of Analysis) is displayed. However, various other embodiments may utilize different procedures in requesting the appropriate data. The following flowchart illustrates a query function for requesting a lab search report:

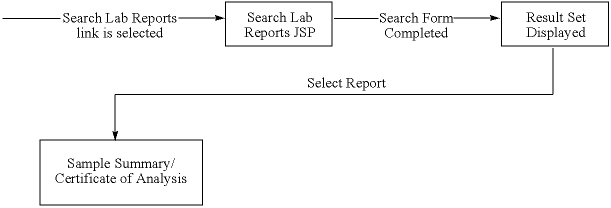

Other query functions available on embodiments of the present invention include safety, environmental management, communications, quality management, quality incident reports, alerts, tracking, shipping, best practices, billing, ordering, maintenance management, warehouse management, and/or the like. Such further and other queries are accessed in the same manner as heretofore described.

Further Functionality included in system portals of the present invention includes ability to View Certificates of Analysis, View Sample Summary Reports, View History of Sample Summary Reports & Certificates of Analysis, Pass/Fail Sample Alerts, Sample Status Alerts, Quality Alerts, SOP Alerts, Statistical Process Control Graphical Trending (gas and chemical), Queries for old data, and/or the like.

Embodiments of the present invention provide access to shipping data concerning products, gas, pipelines, cylinders, samples, and/or the like. Query functionality includes queries By Barcode/RF tag, By Item, By Container, By Lot Number, By Part Number (Internal), By Part Number (External), By Location, By Status, By Expiration Date, By Pending Orders, By Gas Cabinet or CDU, and/or the like. Data such as Inventory Reports, Cabinet and Usage History, Alerts, and/or the like may be queried from the source data systems. Alerts for the present invention may include alerts Expiration Date (Various time length i.e. 1 month, 3 months, 6 months . . . ), minimum Inventory, Back Orders, and/or Procedure Violation.

Embodiments of the present invention further contain system control and data acquisition databases. These databases can control the frequency of alerts for sampling, alerts for system portal operation, can identify system problems, system non-functionality, system slowdowns, and/or the like. Typically, a system of an embodiment of this type would be a software based control program, such as produced by Microsoft and/or the like. Various functions controlled by embodiments of a control system can include network mapping information, such as Configuration of major components, Manufacturer, Model, Serial number, Size, Capacity, system tools connected, Piping layouts, Valve locations, system tool locations, History of Event analysis, and/or the like. Various alerts created by a control system of the present invention can be system related or process control related, such as Excess flow rates, Low flow rates, Excess total usage, Continuous flow from a system which normally flows has an intermittent usage, Temperature, Pressure, Flow Throughput, Purity, Consumption, Cylinder Switching for process controls and system overload and/or system malfunction for system monitoring.

Embodiments with an environmental management or information database provide functionality such as View/Search Bills of Lading, Access MSDS, View Regulatory Data-Link to Industry Web sites, Edit/Create Service Request Forms, Summary Reports of Service Requests, View Pickup Schedules, View Audit Surveys, Lab Pack, Sampling, Analysis, and Waste Handling Procedure, Required PPE data, Accident Reporting Procedure, Forms and Contacts, Training schedule, Interface with the new container tracking system, and/or the like. Various alerts may include Change in MSDS or new MSDS issued per site and/or Government Permit Expirations and Reporting Quantities.

Various embodiments of a quality reporting system or quality control system of the present invention provide functionality including, in some embodiments, View Reports (Trend Reports, Quality Team Progress Reports, etc.), View Workflows, View/participate Discussion Area on Quality Incident Report (QIR) and Best Practices, View Customer Complaints, Alerts (including, but not limited to nor requiring, Accident Reports, QIR Updated, Safety), Processing of the data by: Date, Gas, Location, Country, Seriousness (impact), customer, View metrics on Quality incidents statistics based on Key words input during edition of QIR cards), Input QIR following a key word architecture, Extend the QIR to minor incidents and improvement suggestions, (see TGCM FAQ forms), and/or the like.

Further functions of the present invention can allow access to organization directories, contact lists, work orders, maintenance, best practices and/or the like. Inside users and, in some embodiments, outside users will be able to access organization wide directories to better facilitate communication within an organization.

Various embodiments of the present invention provide multiple levels of security for components of the system. In various embodiments, security will be maintained in the system portal in multiple layers. Various levels of security include physical level security; firewall, program component; application level security, data level security, and application level security.

Firewall security is common in the art and can include opening and closing specific ports and the like upon entry f a password, recognition of a marker, such as a carrot, and/or the like.

Other functionality of embodiments of the present invention includes alert functionality. Embodiments of the present system with alert functionality allow users to view alerts across a plurality of source systems and/or system components from the system portal of the present invention. In various embodiments, alerts are broadcast upon a user logging in. Each user's homepage can be configured to provide alert information for matters of responsibility and/or concern to that user.

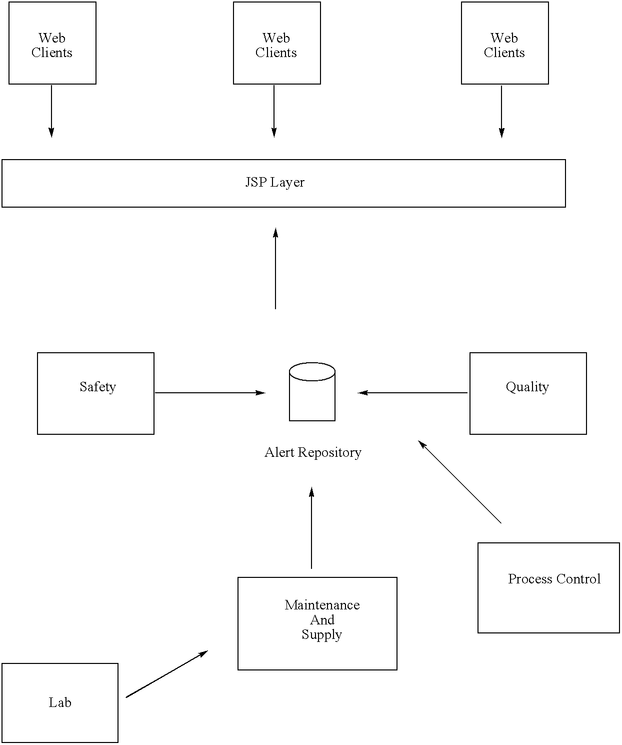

In an embodiment, an alert notification occurs in the following manner:

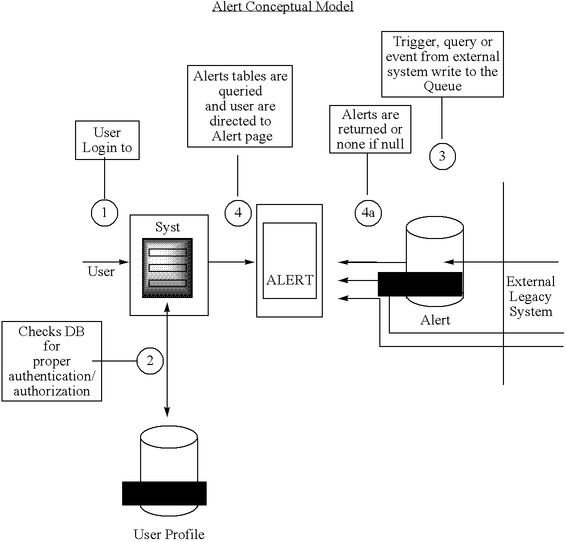

Other embodiments with alert functionality notify users via e-mail when an alert within the user's responsibility is signaled. Alerts can be activated for all user groups and for all functionality.

Program content security can include security that is based on the user profiles that reside in the system program component database. The system portal users will login to the portal with a username and password. The system program component verifies the username and password and retrieves the user profile from the program component database. The user profile will contain a user group or role. The server-side JavaScript that Program component uses can retrieve the user role from the Program component session information. Using the role, the JavaScript can be written to control the content that the user will see and can be used to control access to other applications that will be used via Program component.

Program component application security is maintained by defining database user accounts. The accounts will be set up to enforce general data level access rules (i.e., read only). Application logic written in system program component will make use of these connections retrieve data from the system program databases.

Application level security is the security provided to the individual databases, the read/write function of the databases. This level of security is typically configured to only allow internal users to gain access. However, in various other embodiments, users outside of the firewall will have access to the databases. Security controls placed on access to the databases are usually in place to protect system integrity and prevent unauthorized tampering with the various source systems except for those allowed access.

Other embodiments of a system of the present invention associate web servers that provide the capability to run server-side JavaScript inside the web server. This blurs the distinction between Web serving and application serving. However, as an application becomes larger or more complex, application serving provides greater speed of processing. Other embodiments of a system of the present invention are one entire web side server application with little to no processing on the application side.

What is claimed is:

1. A method of providing personalized access to operational aspects of a gas supply system, comprising:
a) providing a portal configured to provide a primary point of access to data and functions provided by a plurality of source systems of the gas supply system;
b) receiving a request for access to the portal; and
c) generating a personalized response to the request, wherein the personalized response includes links to one or more of the data and functions provided by the plurality of source systems, wherein the access to the data and functions granted to a user via the links is personalized, based on an identity of the user accessing the portal.

2. The method of claim 1, wherein a user profile specifies which of the data and functions provided by a plurality of source systems of the gas supply system the user may access.

3. The method of claim 1, wherein at least one of the plurality of source systems of the gas supply system is a laboratory management system, an environmental management system, a communications system, a quality incident report system, a warehouse management system, a billing management system, an order management, system, a maintenance management system or an alert system.

4. The method of claim 1, wherein a first system of the plurality of source systems stores data related to the generation of a gas product, and wherein the user may generate certificate of analysis (COA) to identify the properties of the gas product.

5. The method of claim 1, wherein a first system of the plurality of source systems provides access to a material safety data sheet data related to a gas product supplied by the gas supply system.

6. The method of claim 1, wherein a first system of the plurality of source systems provides access to shipping data concerning products, gas, pipelines, cylinders, or samples of a gas product supplied by the gas supply system.

7. The method of claim 1, wherein a first system of the plurality of source systems provides access to system control and data acquisition databases (SCADA) of the gas supply system.

8. The method of claim 7, wherein the data and functions of the SCADA include at least one of a network mapping information; manufacturer, model, serial number, size, or capacity data; piping layouts, valve locations, of the gas supply system; and history of event data.

9. The method of claim 1, wherein a first system of the plurality of source systems is an alert system.

10. The method of claim 9, wherein the alert system provides alerts related to at least one of an excess flow rate, a low flow rate, an excess total usage, a temperature, a pressure, a flow throughput, a purity of a product, a consumption rate of a product, and a system overload and/or system malfunction.

11. The method of claim 1, wherein the personalized response to the request comprises an HTML document that includes one or more JavaScript scripts, wherein each JavaScript script provides access to data and functions of one of the plurality of source systems.

12. A computer-readable storage medium containing a program which, when executed, performs an operation for providing personalized access to operational aspects of a gas supply system, the operation comprising:
a) providing a portal configured to provide a primary point of access to data and functions provided by a plurality of source systems of the gas supply system;
b) receiving a request for access to the portal; and
c) generating a personalized response to the request, wherein the personalized response includes links to one or more of the data and functions provided by the plurality of source systems, wherein the access to the data and functions granted to a user via the links is personalized, based on an identity of the user accessing the portal.

13. The computer-readable storage medium of claim 12, wherein a user profile specifies which of the data and functions provided by a plurality of source systems of the gas supply system the user may access.

14. The computer-readable storage medium of claim 12, wherein at least one of the plurality of source systems of the gas supply system comprises a laboratory management system, an environmental management system, a communications system, a quality incident report system, a warehouse management system, a billing management system, an order management, system, a maintenance management system or an alert system.

15. The computer-readable storage medium of claim 12, wherein a first system of the plurality of source systems stores data related to the generation of a gas product, and wherein the user may generate certificate of analysis (COA) to identify the properties of the gas product.

16. The computer-readable storage medium of claim 12, wherein a first system of the plurality of source systems provides access to a material safety data sheet data related to a gas product supplied by the gas supply system.

17. The computer-readable storage medium of claim 12, wherein a first system of the plurality of source systems provides access to shipping data concerning products, gas, pipelines, cylinders, or samples of a gas product supplied by the gas supply system.

18. The computer-readable storage medium of claim 12, wherein a first system of the plurality of source systems provides access to system control and data acquisition databases (SCADA) of the gas supply system.

19. The computer-readable storage medium of claim 12, wherein a first system of the plurality of source systems is an alert system.

20. A system for providing personalized access to operational aspects of a gas supply system, comprising:
a) a plurality of source systems each providing at least one of data and functions related to gas supply; and
b) a portal providing a primary point of access to the data and functions provided by a plurality of source systems of the gas supply system, wherein the portal is configured to:
i) receive a request for access to the portal; and
ii) generate a personalized response to the request, wherein the personalized response includes links to one or more of the data and functions provided by the plurality of source systems, wherein the access to the data and functions granted to a user via the links is personalized, based on an identity of the user accessing the portal.
